(19) United States
(12) Patent Application Publication
(10) Pub. No.: US 2008/0150679 A1
(43) Pub. Date: Jun. 26, 2008

(54) Remote Keyless Entry Device with Integrated Accessible Memory Storage

(76) Inventor: Richard M. Bloomfield, Novi, MI (US)

Correspondence Address: CLARK & BRODY, 1090 VERMONT AVENUE, NW, SUITE 250, WASHINGTON, DC, 20005, US

(21) Appl. No.: 10/568,592

(22) PCT Filed: Jan. 20, 2006
(86) PCT No.: PCT/US2006/001886

§ 371 Date: Feb. 17, 2006

Related U.S. Application Data
(60) Provisional application No. 60/645,018, filed on Jan. 21, 2005.
(60) Provisional application No. 60/709,439, filed on Aug. 19, 2005.

(51) Int. Cl. G05B 19/00

(52) U.S. Cl. 340/5.7; 340/5.72

(57) ABSTRACT

A remote entry device for use in a keyless entry system, such as that used for a vehicle, includes a remote entry component combined with an accessible memory storage component. The memory storage component is located in a common housing with the remote entry component whereby it is convenient to use. Preferably, the memory contains any of a wide variety of information useful to the user of the vehicle, which can be modified or updated electronically. The memory is accessible through an interface port, such as a USB port.

### FIELD OF THE INVENTION

The present invention relates to a keyless entry device combined with an accessible memory storage device. More particularly, the present invention relates to the combination of a remote keyless entry device for a vehicle and a flash drive having memory storage accessible through an electronic interface.

### DESCRIPTION OF THE RELATED ART

Users have found remote keyless entry systems very convenient and these systems have become the choice for locking and unlocking vehicle doors. The typical keyless device, also referred to as a key fob, may be carried on a key chain with the ignition key for the vehicle as well as other keys. Thus, a user typically has the entry device along with the key when using a vehicle. Keyless entry systems may also be used in environments other than vehicles, such as to open office or home doors, and the like.

Flash memory drives have also become popular in recent years as easy, convenient ways to store and move electronic files. For example, a flash drive may include flash memory integrated with an interface to store a file for use with multiple computers using a universal serial bus (USB) or other electronic interface. A user simply plugs the drive into a port on a computer, copies the file to the flash drive and then accesses the file at another computer by interface with the flash drive.

Both the keyless entry device and the flash drive may be attached to key chains or other products that hold them for convenient use. Multiple devices on a common keychain, however, are often unwieldy and bulky. Moreover, though a remote transmitter and a flash drive may be carried on a common keychain, they are unrelated and unable to interact with each other.

### SUMMARY OF THE INVENTION

The invention combines a keyless remote entry transmitter with accessible memory storage to provide a variety of unique functions. In the preferred embodiment, the keyless entry transmitter is used to operate the doors, trunk lid, etc. of a vehicle, and the functions provided by the memory storage relate directly or indirectly to the vehicle whereby the accessible memory can be used as a known flash drive but also provides one or more unique functions related to the vehicle.

While most flash drives may be carried on key chains, belt loops, briefcases and the like, they are inconvenient because they are so often lost or unavailable. Users often remove the flash drive from the keychain and then leave the drive in an interface port whereby the flash drive is unavailable when needed.

A remote entry device, however, is different. People are usually more careful with their car or home keys and lose them less often. Thus, according to a primary aspect of the invention, the accessible memory, such as a flash drive, is made to be always available in a very convenient manner because the memory feature of the flash drive is incorporated into the remote entry device. This combination then allows unique enhancement of the functions and capabilities of the remote entry device. Thus, the invention reduces the number of items carried by a keychain and provides unique functions as described below.

An electronic interface, such as a USB connector, is provided for transferring data, files and the like between the memory of the flash drive and a computer. (While the well-known USB port is the presently preferred embodiment, it should be understood that reference to a USB port herein is exemplary only and includes other interface devices now known and those developed after the filing of this application.) The incorporation of the integrated accessible memory device with a key or keyless remote entry device ensures that the memory is available as long as the user has the keys or device. Thus, a remote entry device, such as a keyless transmitter for a car, includes all the usual buttons for locking, unlocking, panic, trunk open and the like, but also includes a flash drive accessible through an interface. In a preferred embodiment, the interface extends from the device to be connected to a USB port within a computer or on the vehicle.

Another advantage of the invention is the ability to connect the memory to interface ports on a car stereo or navigational system to make the files on the memory storage available for use. Thus, because the files are combined with the vehicle's key the portable flash drive is always available when the vehicle is in use. A variety of files specific to the vehicle are preferably stored on the devices. The files include, for example, an owner's manual as well as promotional videos or interactive media, which can be deleted once accessed. Other files allowing manufacturers to target specific groups or customers based upon the vehicle may be included also.

Providing the owner's manual on the memory of the combined keyless entry system is particularly advantageous because it can be updated by connection to a designated website on the Internet.

The interface may use a cap to protect the connector from external damage. The device may be configured such that the connector is movable either linearly or rotationally between protected and use positions. The cap can be connected to a key chain and the interface removed from the key chain when used. The cap prevents dirt, dust and other particles from damaging the interface or getting inside the remote entry device.

The memory capabilities, or size, can vary in accordance with the space available, the size of memory desired, and the particular memory technology chosen. Flash memory elements and circuitry may be distributed in unused locations in known keyless entry devices and transmitters such that the size of the device or transmitter is not increased. If needed, however, the device may be made slightly larger to accommodate the elements and circuitry to provide any increased memory capacity or other capabilities.

Another advantage of the present invention over the known art is the ability of the interface or flash drive components to communicate with the remote entry device. For example, the functions of the existing components may be modified via the interface, or some of the memory capacity may be shared with the components that control the normal functions of the entry device. Another link may be made when the interface draws power from a computer or vehicle during connection to recharge the battery of the entry device. This feature provides a fully powered transmitter that reduces remote entry failures and increases customer satisfaction.

The invention, therefore, provides the user with important information, data or files that is less likely to be lost or misplaced. Further, a driver or other user of a vehicle can access and control their environment in a simple manner and without multiple gadgets and items. For example, the driver can load mp3 music files onto the flash drive from a computer and the access the files in the vehicle for playback by its interface with a port on the vehicle stereo system.

The types of files, data or information made available to the vehicle are limitless. A pass code may be provided on the memory of the flash drive that is required to start a vehicle. For example, the remote entry device includes a flash drive that communicates with the vehicle to start the ignition using the pass code. Vehicle owner contact information also may be provided on the memory that helps facilitate return of keys or keyless remote entry device if they become lost. Contact information also may be helpful to repair personnel or anyone else trying to contact the owner.

Accordingly, the disclosed embodiments are directed to a remote entry device having integrated memory storage. The device is portable so that a user may carry it to various locations, and the memory storage is accessible via a universal serial bus or other interface. Further, the remote entry device may interact with the memory to provide support, updates and the like.

According to the present disclosure, a remote entry device includes a remote entry component having a transmitter and accessible memory storage component contained in a common housing.

According to the present disclosure a combined remote entry device and accessible memory includes a housing having a removable cover. The remote entry component is enclosed by the housing and draws power from a battery. The remote entry device also includes a memory storage component having a memory accessible through a connector extending from the housing. The memory stores data regarding the remote entry device. The remote entry device also includes at least one sliding part on the outside of the housing that detaches the cover from the housing.

According to the present disclosure, another remote entry device includes a housing and a cover to attach to the housing. The cover includes an aperture and connection guides to insert into the housing. The remote entry device also includes a remote entry component within the housing. The remote entry component includes a button to indicate a signal to transmit to a receiver and a battery. The remote entry device also includes a memory storage component within the housing. The memory storage component includes a printed circuit board to support a flash drive connected to a memory that stores data regarding the remote entry device. The remote entry device also includes a connector that extends from the housing to interface with a port to allow access to the flash drive and to recharge the battery. The cover encloses the connector when attached to the housing. The remote entry device also includes a light emitting diode (LED) to indicate the connector is engaged with the port.

According to the disclosed embodiments, a keyless system is disclosed. The keyless system includes a receiver to facilitate in performing an action at a location. The keyless system also includes a remote entry device having a transmitter to transmit a signal to the receiver. The signal corresponds to the action. The keyless system also includes a memory storage component within the remote entry device that stores data and is accessible via a flash drive. The keyless system also includes a connector for the remote entry device to interface the memory storage component with another device.

According to the present invention, a method for performing an action within using a remote entry device is disclosed. The method includes connecting the remote entry device to a port. The method also includes reading data regarding the action from a memory storage component within the remote entry device. The method also includes performing the action with a device hosting the port.

According to the present invention, a remote entry device is disclosed. The remote entry device includes means for transmitting a signal in a keyless system. The remote entry device also includes means for storing data regarding the remote entry device. The remote entry device also includes means for connecting to an interface to access the means for storing.

Additional features and advantages of the disclosed embodiments will be set forth in the description that follows, and in part will be apparent from the description, or may be learned by practice of the invention. The objectives and other advantages of the disclosed embodiments may be realized and attained by the structure and functionality particularly pointed out in the written description and claims as well as the drawings.

### BRIEF DESCRIPTION OF THE DRAWINGS

The drawings, which are included to provide further understanding of the invention, are incorporated in and constitute a part of the specification. The drawings illustrate embodiments of the present invention and together with the description serve to explain the principles of the invention.

FIG. 1 illustrates a remote entry device having an integrated memory storage according to the disclosed embodiments.

FIG. 2 illustrates a remote entry device with an attached cover according to the disclosed embodiment.

FIG. 3 illustrates a remote entry device with a detached cover according to the disclosed embodiments.

FIG. 4 illustrates components within a remote entry device according to the disclosed embodiments.

FIG. 5 illustrates a flowchart for using a remote entry device having a memory storage component according to the disclosed embodiments.

### DETAILED DESCRIPTION OF THE PREFERRED EMBODIMENTS

Reference will now be made in detail to the preferred embodiments of the present invention, examples of which are illustrated in the accompanying drawings. It is to be understood that the foregoing discussion and the following detailed description are exemplary and explanatory, and are intended to provide further explanation of the invention as claimed.

As noted above, the present invention relates to keyless remote entry devices that have an integrated memory that is accessible through a connection, such as a USB connection. The present invention facilitates an interface between, for example, a vehicle and the keyless entry device using the connection. The memory may be accessible through a flash drive. Together, these components may interact to provide features, capabilities and advantages beyond those available to the components separately.

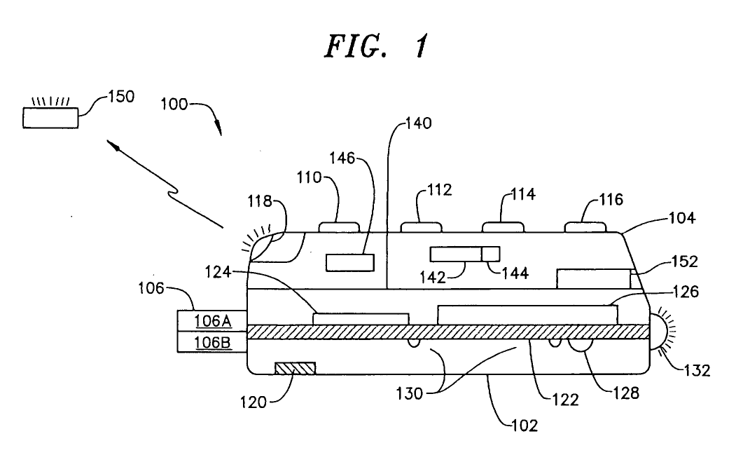

FIG. 1 depicts a remote entry device 100 having integrated memory storage according to the disclosed embodiments. Remote entry device 100 may include memory storage component 102 and remote entry component 104. The two components 102 and 104 are preferably coupled together by wall 140. Memory storage component 102 also includes connector 106. Connector 106 allows memory storage component 102 to connect to an adapter or other interface. Preferably, connector 106 connects to a USB port. Connector 106 may include upper section 106A and lower section 106B.

Remote entry component 104 supports a remote keyless entry system. Remote entry component 104 may support infrared operations, or may use a challenge-response authentication over a radio frequency. The remote keyless entry system may remotely lock or unlock a door or other opening to allow access to premises or vehicles. Remote entry component 104 may eliminate the need to physically manipulate a key within a lock to gain access to the premises or vehicles. Further, remote entry component 104 may perform these operations at a distance, and not need a line of sight to send a signal.

Remote entry component 104 also may include a remote keyless ignition system, if device 100 is for use with motor vehicles. Remote entry component 104 may send pulses of radio frequency (RF), or infrared, energy on a particular frequency. Remote entry component 104 may use transmitter 118 to perform the send and receive operations. Transmitter 118 may indicate it is in use by providing any sort of indication that remote entry component 104 has been activated.

For example, when a button is pushed on remote entry component 104, a code is transmitted via transmitter 118 to a receiver 150. Receiver 150 may be within a security system, such as on a vehicle. Receiver 150 is tuned to a frequency used by transmitter 118, such as 300 to 400 Megahertz (MHz). A controller chip 142 may use a hopping code or a rolling code to provide security for remote entry component 104. For example, controller chip 142 may use a 40-bit rolling code, which may provide about 1 trillion possible codes for use.

Using the above example, controller chip 142 may include memory location 144 that holds a current 40-bit code. When a button, such as button 110, is pushed on remote entry component 104, transmitter 118 sends the 40-bit code along with a function code that indicates to receiver 150 what action is to be taken, such as lock doors, unlock doors, sound alarm and the like. Receiver 150 also may have a memory location that holds the current 40-bit code. If receiver 150 receives the expected 40-bit code, then the requested action is performed. If not, then no action may be taken.

Transmitter 118 may use a random number generator 146 when the 40-bit code is sent. Random number generator 146 may correlate to a random number generator within receiver 150. Transmitter 118 may use random number generator 146 to identify a new code that is stored in memory location 144. When receiver 150 receives a valid code, the same random number generator is used within receiver 150 to pick a new code. Thus, transmitter 118 and receiver 150 are synchronized, and receiver 150, for example, may open the door if it receives the code it expects.

If the distance between transmitter 118 and receiver 150 is great, then they may become out of synch if a button is accidentally pushed on remote entry device 100. Receiver 150 may solve this problem by accepting any of the next 256 possible valid codes in the pseudo-random number sequence. Thus, a button could be pushed “accidentally” for 256 times and receiver 150 should still be able to accept the appropriate signal from transmitter 118.

The type of operation, or signal sent, may be determined by the buttons on remote entry component 104. For example, FIG. 1 depicts four buttons on remote entry component 104. Button 110 may activate a lock signal. Button 112 may activate an unlock signal. Button 114 may activate a panic signal. Button 116 may activate a trunk “open” signal. The number of buttons disclosed by the present invention is not limited to four, and may be any number desired. The number of buttons may correspond to the number of signals or functions for remote entry component 104. Further, the above-disclosed functions are not the only functions available.

Other functions may be available depending on the type of remote keyless entry or ignition system desired. For example, button 116 may activate an engine start operation for a vehicle. Alternatively, other functions may include opening a tailgate, closing or opening windows, playing music and the like.

Remote entry component 104 also includes a battery 152 that provides power for transmitter 118. Battery 152 may be any battery used in remote controls and keyless entry devices. Battery 152 may be rechargeable or replaceable. Remote entry device 100 is shown with remote entry component 104 housed on a top section, while memory storage component 102 is housed in a lower section. Remote entry device 100 may house components 102 and 104 in any manner, and is not limited to the configuration shown in FIG. 1. Components 102 and 104, however, may be separated so that they may be detachable from each other.

Preferably, memory storage component 102 includes a USB flash drive. A USB flash drive may include NAND (Not AND) type flash memory integrated with a USB interface that is used as a small, lightweight, removable data storage device. Memory storage component 102 may use the USB serial bus standard for connecting remote entry device 100 to other devices, such as a computer. A USB system may have an asymmetric design that includes a host controller and multiple devices connected in a tree-like fashion using hubs. In USB terminology, devices, such as remote entry device 100, may be referred to as functions.

Memory storage component 102 includes a printed circuit board (PCB) 122. Connector 106 protrudes from memory storage component 102, and may be covered by a removable cap that attaches to remote entry device 100. Connector 106 may be a standard type-A USB connection that allows remote entry device 100 to be connected directly to a USB port. Alternatively, connector 106 may include a thin plug to mate with a standard USB port.

Memory storage component 102 may be active when powered by a USB connection. Thus, memory storage component 102 does not require an additional external power source or battery, and may be run off the supply afforded by a USB connection. This connection may be about 5 volts or about 100 to 500 mAmps, and may be made by a direct connection to a USB port, or via a USB hub.

Alternatively, power may be supplied by the battery or other power source for remote entry component 104. Thus, even if the power supplied via the connection to the USB is deficient, memory storage component 102 may be activated because it can draw power from remote entry component 104. This feature may be desirable if remote entry device 100 is connected to a hub that does not have the proper amount of power to activate remote entry device 100.

Referring to FIG. 1, memory storage component 102 includes PCB 122. PCB 122 may have power circuitry and integrated circuits mounted on its surface. For example, USB mass storage controller 124 is mounted on PCB 122. USB mass storage controller 124 provides a seamless linear interface to block-oriented serial flash device while hiding the complexities of block-orientation, block erasure and wear balancing. USB mass storage controller 124 may include a small RISC microprocessor along with a small amount of on-chip read-only memory (ROM) and random-access memory (RAM).

Memory chip 126 includes a flash memory chip that stores data. Preferably, memory chip 126 includes a NAND-type configuration. Remote entry component 104 also includes crystal oscillator 128. Crystal oscillator 128 produces a clock signal, such as 12 MHz, and controls the data output through a phase-locked loop.

Remote entry device 100 may use emitting diode (LED) 132 to alert a user that remote entry device 100 is connected to a USB port and active. The signal should prevent someone from just pulling device 100 from a port while it is connected. Further LED 132 may be activated when remote entry device 100 is used to indicate a signal is being transmitted from transmitter 118.

Write protect switch 120 may indicate whether remote entry device 100 is in write protection mode for data within memory chip 126. For example, when write protect switch 120 is “on,” the data within memory chip 126 may not be over written. Unpopulated space 130 may serve as a location for a second memory chip on PCB 122. A second space allows the use of a single PCB 126 for more than one storage size device, as well as allowing for increases in the memory available for memory storage device 102. Other components on PCB 126 or within memory storage component 102 may include jumpers and test pins for testing during manufacture of the flash drive components or loading code into storage controller 124.

Thus, remote entry device 100 includes remote entry component 104 attached to memory storage component 102 to use within a keyless system. Components 102 and 104 may interact to provide additional features for remote entry device, as disclosed below. Remote entry device 100 may be composed of plastic or any other lightweight material that provides protection to the internal components.

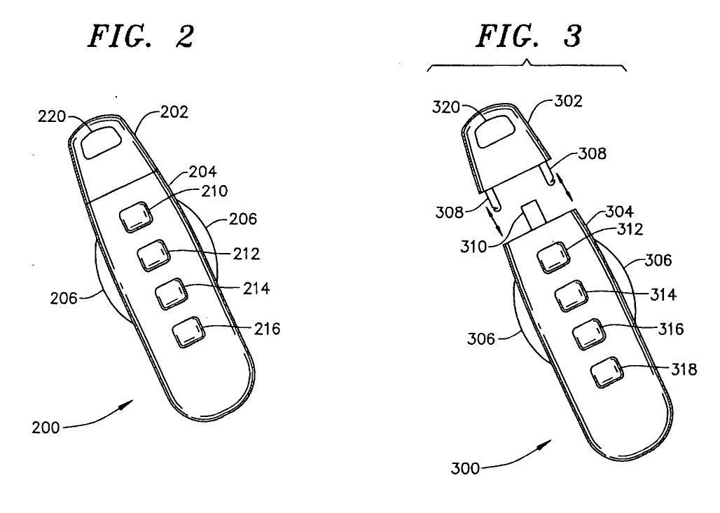

FIG. 2 depicts a remote entry device 200 with an attached cover 202 according to the disclosed embodiments. Remote entry device 200 may be analogous to remote entry device 100 disclosed by FIG. 1. Remote entry device 200 also may include a remote entry component and a memory storage component. The remote entry component may send a signal to a receiver within a keyless system for various functions to be performed, such as locking doors. The memory storage component may be a flash memory drive that stores data or information via a USB connection.

Remote entry device 200 includes housing 204 that encompasses the remote entry component and the memory storage component. Housing 204 may include markings or designators on its outside that are used for cross-marketing or co-branding remote entry device 200. A designator may refer to any name, mark, logo, indicator, trademark, service mark, and the like that relates to a company or other entity. The designator may tie in manufacturers of components of remote entry device 200, such as the flash drive or memory. Housing 204 may include more than one designator, depending on the space available.

Remote entry device 200 also includes cover 202. Cover 202 is detachable from housing 204 and covers the connector for the memory storage component. Cover 202 prevents foreign materials from entering remote entry device 200. Cover 202 also includes aperture 220. Aperture 220 allows remote entry device 200 to be attached to an item for carrying portable devices, such as a keychain.

Remote entry device 200 also includes sliding parts 206. Sliding parts 206 may facilitate the detachment of cover 202. Remote entry device 200 also has buttons 210, 212, 214 and 216 that determine the type of signal to transmit. For example, button 210 may send a signal to lock doors, button 212 may send a signal to unlock doors, button 214 may be a panic signal that sets off an alarm and button 216 may send a signal to open the trunk. Alternatively, buttons 210, 212, 214 and 216 may send any type of signal that causes an action to be taken at the receiving end of the keyless system.

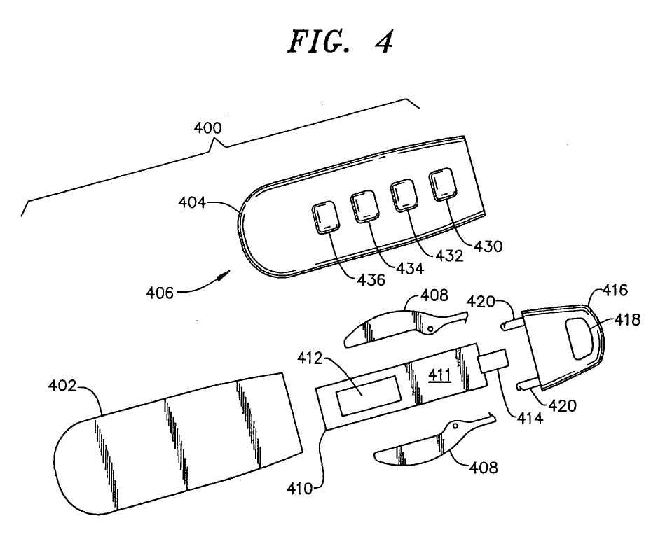

FIG. 3 depicts a remote entry device 300 having a detached cover 302 according to the disclosed embodiments. Remote entry device 300 also may be analogous to remote entry device 100 disclosed in FIG. 1. Remote entry device 300 also may include a remote entry component and a memory storage component. The remote entry component may send a signal to a receiver within a keyless system for various functions to be performed, such as locking doors. The memory storage component may be a flash memory drive that stores data or information.

Cover 302 is shown as being detached from housing 304. Cover 302 attaches to housing 304 using connection guides 308. Connection guides 308 may be inserted into a hole or other receiving means to securely fasten cover 302 to housing 304. Preferably, connection guides 308 have notches that latch onto housing 304 or sliding parts 306. Sliding parts 306 may move along the sides of housing 304 to remove cover 302. In FIG. 3, sliding parts 306 are depicted in an “up” position.

USB connector 310 extends from a flash drive within housing 304. USB connector 310 allows remote entry device 300 to be inserted into a USB port to access the memory of the flash drive. Further, USB connector 310 may allow remote entry device 300 to draw power from the USB port. When cover 302 is fastened to housing 304, USB connector 310 is protected from outside elements. Further, cover 302 may prevent USB connector 310 from being bent or broken. Cover 302 also may prevent foreign materials, such as dirt, dust, sand and the like, from getting into USB connector 310 and housing 304.

Buttons 312, 314, 316 and 318 may be pressed to cause a signal to be transmitted from housing 304. Each button may correspond to a different signal to be transmitted, as disclose above. Cover 302 also may serve as a safeguard to prevent inadvertent signals from being transmitted. In other words, the act of pressing buttons 312, 314, 316 or 318 may not result in a signal being transmitted if cover 302 is attached to housing 304. Alternatively, if cover 302 is attached to housing 304, then signals may be transmitted as remote entry device 300 probably is not connected to a USB port and the signals should not be interfered with by a computer or other equipment.

Remote entry device 300 also includes aperture 320. Aperture 320 connects remote entry device 300 to a keychain or other item for carrying key fobs, keys and the like. Thus, remote entry device 300 may be kept with other items that a user normally takes with them on their person. Aperture 320 may be placed within cover 302, as shown in FIG. 3. Alternatively, aperture 320 may be placed within housing 304. By being in cover 302, however, aperture 320 may allow housing 304 to be detached for use, while cover 302 remains on the keychain to prevent it from being lost.

FIG. 4 depicts components within remote entry device 400 according to the disclosed embodiments. Remote entry device 400 is shown with its components apart before an assembly of the components. Remote entry device 400 may include additional components, and the number of components is shown for illustrative purposes only. FIG. 4, however, does not limit the number, type or function of components for use within remote entry device 400.

Remote entry device 400 includes two primary components within housing 406. Remote entry component 404 and memory storage component 410 may be analogous to the components disclosed above. Remote entry component 404 transmits a signal in response to pressure on a button 430, 432, 434 or 436. The signal prompts a receiver to initiate an action, such as locking a door. Remote entry component 404 may initiate 4 different actions from the 4 buttons shown. Alternatively, remote entry component 404 may include any number of buttons for any number of different actions.

Memory storage component 410 stores data or files onto a memory 412. PCB 411 provides the structure for memory storage component 410. Preferably, memory storage component 410 is a USB flash drive that connects to a USB port using USB connector 414. Other devices may reside on PCB 411 that controls the storage of data within memory 412.

Remote entry device 400 also includes sliding parts 408. Sliding parts 408 may be located within housing 406 between remote entry component 404 and bottom portion 402. Bottom portion 402 may be a sturdy, lightweight construction that protects the under side of memory storage component 410. Bottom portion 402 is connected to remote entry component 404 to form housing 406. Sliding parts 408 may be placed such that they do not touch PCB 411.

Alternatively, sliding parts 408 may interact with PCB 411 such that memory storage component 410 slides out from housing 406 when remote entry device 400 is assembled. This feature may provide further protection for memory storage component 410 and USB connector 414. A user may keep the flash drive on PCB 411 in housing 406 until such time it is needed to interface with a USB port.

Cover 416 is attachable to housing 406 and provides protection for memory storage component 410. Cover 416 is placed over USB connection 414. Cover 416 is secured to housing 406 by connection guides 420. Connection guides 420 may include notches that interact with sliding parts 408 to secure cover 416. Cover 416 also includes aperture 418. Aperture 418 provides a hole to attach remote entry device 400 to a keychain and the like.

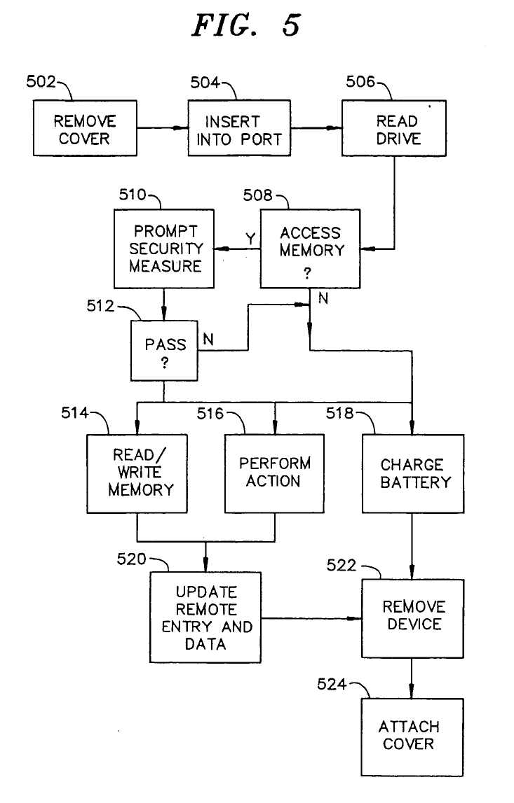

FIG. 5 depicts a flowchart for using a remote entry device having a memory storage component according to the disclosed embodiments. FIG. 5 depicts steps, processes and methods that may be used in conjunction with FIGS. 1-4 disclosed above.

Step 502 executes by removing a cover to the remote entry device. As disclosed above, the cover provides protection to the USB connector and prevents dirt or other foreign particles from getting into the remote entry device. The cover may be attached to a keychain or other item that attaches the remote entry device with other portable devices. The cover may be removed in a variety of ways, and connected to the housing of the remote entry device. The cover may be slid, pushed, pulled and the like from the housing. Further, the removal of the cover may bring out the USB connector from the housing in order to be connected to a computer or other device.

Step 504 executes by inserting the remote entry device into a USB port. The USB port may be integrated with a computer or other device that allows instructions and data to be read from the remote entry device, or stored on the remote entry device. As disclosed above, the USB connector is inserted into a port. Preferably, the USB connector is a Type A USB connector. Alternatively, the USB port may be within a vehicle so that information or data may be downloaded onto the vehicle's computing system, or another device within the vehicle, such as stereo system.

Step 506 executes by reading identification information or data pertaining to the flash drive and memory within the remote entry device. For example, the remote entry device may be assigned to a specific vehicle or user, and this information should be checked before proceeding with any further actions. The computing device enclosing the USB port may cross-check the identification with stored records or files.

Step 508 executes by determining whether the memory associated with the flash drive will be accessed. Memory access may prompt special consideration because a user may not want the information or data stored on the remote entry device to be modified or deleted during all USB connections. If no, then the flowchart proceeds to step 518 where the battery within the remote entry device may be recharged while the USB connection is in place. If step 508 is yes, then the flowchart proceeds to step 510.

Step 510 executes by prompting security measures from the remote entry device. Because remote entry to a vehicle may be tied to a specific key or signal, the flash drive may store specific identification information or data that allows the contents of the memory to be accessed only by certain users or on specified systems. Thus, unauthorized users may not access the memory in the remote entry device. Further, the remote entry device may be used with the vehicle or other receiver that receives signals from the remote entry device. The remote entry device, therefore, may not be used on any vehicle having a USB port, but the one that is assigned to the remote entry component of the device.

Other safeguards and security measures may be implemented in step 510 to prevent unauthorized use of the remote entry device. Another example may be to password protect the information or data within the memory when the key and remote entry device is left with another party to use or service the vehicle. The user does not want the dealer, mechanic, valet and the like to have access to their information on the remote entry device. Thus, step 510 may ensure that the information or data is protected in the event the keys are lost or being used by someone else.

Step 512 executes by determining whether the security measures passed in step 510. If no, then the flowchart proceeds to step 518 where the battery within the remote entry device can be recharged, but access to the flash drive or the memory is not allowed. If step 512 is yes, then the flowchart proceeds to steps 514, 516 or 518. Steps 514, 516 and 518 may be executed simultaneously or separately. Steps 514, 516 and 518 also may be executed in any order, and are not necessarily dependent upon each other.

Step 514 executes by reading or writing to the memory within the remote entry device. The memory is accessible via the flash drive. Reading and writing to the memory may be desirable for many reasons. For example, the information or data stored within the memory accessible by the drive is used to perform functions on the computer or within a computing system in the vehicle. For example, a user may transport their mp3 files on the memory of the flash drive. The user may plug the remote entry device into a USB port in the music system of the vehicle to play the mp3 music files. The disclosed embodiments read the mp3 files from the memory of the remote entry device into the playlist for the music system.

Another example may be including a pass code in the memory that is required to interface with the vehicle. The pass code also may be used to start the vehicle under certain conditions. This feature may be provided as a secondary security measure in addition to having a key with a pass code. Alternatively, the pass code in the memory of the remote entry device may allow a bypass to the requirement of a key with the pass code. This feature may be desirable when the primary key fails for any reason, and a user has no other way to start the vehicle, and may be distinguishable from the normal security measures disclosed above.

Other examples of reading or writing to the memory may include providing user contact information over the USB connection. If the remote entry device is misplaced or lost, the contact information may facilitate the return of the device, along with the keys, to the owner, or user. Other information may be placed in the memory that is useful to the user.

For example, the owner's manual or an operating manual may be accessible for the vehicle or any other system using the remote entry device. Further, the manual may be backed up in electronic form on a computer or other storage to free up memory space on the remote entry device. If the user desires to put the manual back in the memory of the remote entry device, then the user connects to the remote entry device to the USB port on that backup device.

With regard to vehicle, the manual in the memory may replace the printed manual, which, in turn, saves costs. Further, the manual may be updated on a continuous or periodic basis. Recalls, recommended maintenance, vehicle records and the like may be updated or replaced when a connection is made with a USB port. The remote entry device may access a connection over the Internet to download the latest information regarding its system or vehicle. The manual also may include information on troubleshooting or replacing parts within the security system. Any system using the remote entry device to signal a receiver may include operating instructions, manuals, updated product information and the like within the memory for easy access and up-to-date information.

Other readable features corresponding to the specific system or vehicle using the remote entry device include interactive programs or video instructions for explanations of features on the system or vehicle. The specific program or video may be tailored to the vehicle model and type, with portions of the content shown identified after the remote entry device has been connected to the vehicle over the USB connection. Thus, general instructions may be used for some portions of the program or video along with more specific ones. This feature may result in a more personal or informative experience for a new vehicle purchaser as opposed to hearing instructions from a compact disc or reading them in a manual.

Advertisements, product tie-ins, cross-marketing and the like also may be read from the memory of the remote entry device. Manufacturers of the flash drive, device, vehicle, entry system and the like may co-brand with each other to increase consumer awareness using designators, trademarks, logos and the like. Superior reputation and brand loyalty may be leveraged to increase product appeal. This feature may be desirable because cross branding and niche marketing is becoming more popular to ensure advertising dollars are spent properly in reaching a target market. Coupons and special deals also may be accessed and printed from the memory to be redeemed by the purchaser of the system using the remote entry device. Further, the manufacturer of the remote entry device may recoup costs by selling memory space on the device.

The memory within the remote entry device may include navigation software from the flash drive that is loaded onto a navigation system or global positioning system (GPS) device. Updated navigation software may be used to replace old or out-dated navigation software. A user may download or copy the most current version of software onto the remote entry device via the USB connection. When coupled to the vehicle or navigation system, the new software may be read and loaded onto the system. Thus, discs or additional storage mediums may be avoided. Further, the user may save a copy of the software on a computer or hard drive for backup purposes. The vehicle or navigation system also may write data onto the memory within the remote entry device regarding driver preferences that are then communicated to the software developer or equipment manufacturer. In other words, a true two-way communication link may be established regarding the use and maintenance of the navigation software.

Step 516 executes by performing an action based on the information or data on the memory within the remote entry device. Step 516 may differ from step 514 in that the information or data read from the memory results in an action taking place within the security system itself, or on the computer hosting the USB port. The action may or may not be known to the user. For example, the remote entry device may include instructions to automatically detect an internet connection, and, if found, to connect to a website or URL. The actions taken may be performed in conjunction with step 514, or, alternatively, after all read or write operations have taken place.

One action that may be taken in step 516 is setting or resetting driver preferences for the use of the vehicle or system. For example, the remote entry device may use the USB connection to interface with the vehicle to change the settings of all the adjustable functions for the driver or passengers. The adjustable functions may include seat position and elevation, temperature, fan speed level, mirror position, radio stations, lock controls and the like. As different drivers use the vehicle, then the settings may be replaced by those preferred by each individual driver. A user may set their preferences using a graphical user interface (GUI) that is prompted when the remote entry device is connected to a USB port on a computer. After the preferences are set, they are uploaded to the vehicle when the USB connection is made in the vehicle. Alternatively, if a user moves from system to system, the user may use the same preferences at the different vehicles.

Another action may be the synchronization of clocks or other instruments within the system or vehicle. Further performed actions may include vehicle ignition, system availability for repairs, diagnostics or maintenance, and the like. Step 516 also may include overriding vehicle, or system, preferences or commands for safety reasons. For example, a USB connection to a vehicle of the remote entry device may activate a transponder to send out periodic signals on vehicle location.

The vehicle could be turned off using the information or data on the memory within the remote entry device. A program or settings in the memory may perform an action to disable ignition when certain criteria are met as defined by the program. For example, failure to input the proper security code or the detection of erratic driving may cause the engine to be turned off by a signal generated within the vehicle upon prompting by the remote entry device. Further, after a time period has elapsed with the remote entry device connected in the USB port, an alert may be given due to inactivity of the vehicle. Alternatively, the locks may be activated to lock the vehicle after a time period. Moreover, the ignition may be cut if the vehicle is left standing for a period of time so as to not waste fuel.

Step 518 executes by charging the battery, or any other power storage component, within the remote entry device. As noted above, the USB connection may provide a nominal 5 volt wire from which a USB device may power itself. Thus, the remote entry device may power itself during a USB connection with a computer, system or vehicle. Delivered voltage may fluctuate between about 4 volts to about 5.25 volts. Further, the USB connection may deliver up to 500 milliamps. Using these parameters, the remote entry device may recharge itself when the flash drive or other components are not in use. The feature of recharging the battery may keep the signal strength of the transmitter strong. Further, replacement batteries may be avoided, which results in higher consumer satisfaction. A reliable and strong remote entry device also raises user confidence in the overall quality of the vehicle or system.

Once the user indicates the remote entry device is to be removed from the USB port, then step 520 may execute by updating the remote entry device and any information or data. As disclosed above, settings, preferences, logs and the like may be useful for later data collection efforts and to personalize the product to the user. Step 522 executes by removing the remote entry device from the USB port. Step 522 may occur after a prompt has been given to the user that removal of the remote entry device is appropriate to as to not interrupt any operations using the device. Step 524 executes by attaching the cover to the housing of the remote entry device.

It will be apparent to those skilled in the art that various modifications and variations may be made in the disclosed embodiments of the present invention without departing from the spirit or scope of the invention. Thus, it is intended that the present invention covers the modifications and variations of the disclosure of the specification provided that they come within the scope of the claims and their equivalents.

I claim:

1. A remote entry device comprising:
a remote entry component within a housing, wherein the remote entry component includes a transmitter to transmit a signal;
a memory storage component within the housing, wherein the memory storage component includes a flash drive coupled to a memory; and
a interface to allow user access to the flash drive.

2. The remote entry device of claim 1, wherein said interface allows access via a universal serial bus (USB) interface, an infrared signal, a low frequency radio signal, Bluetooth or a radio frequency signal.

3. The remote entry device of claim 1, wherein the memory includes data for a preference setting for a user, such that the preference setting is transferred from one location to another location.

4. The remote entry device of claim 1, wherein the memory includes a pass code.

5. The remote entry device of claim 4, wherein the pass code corresponds to the remote entry component to start a vehicle.

6. The remote entry device of claim 1, wherein the housing includes a designator to identify the memory storage component.

7. The remote entry device of claim 1, wherein the housing includes designator for cross-branding or cross-marketing the remote entry device.

8. The remote entry device of claim 1, further comprising a file including an MP3 player.

9. The remote entry device of claim 1, further comprising a password function to deny access to at least one file stored in the memory.

10. The remote entry device of claim 1, wherein the memory includes contact information.

11. The remote entry device of claim 10, wherein the contact information relates to a user.

12. The remote entry device of claim 1, further comprising a battery.

13. The remote entry device of claim 12, wherein the battery is charged through the connector.

14. The remote entry device of claim 1, wherein the memory includes a file having an owner's manual.

15. The remote entry device of claim 1, wherein the memory includes at least one marketing material.

16. The remote entry device of claim 1, wherein the memory includes a software program.

17. The remote entry device of claim 16, wherein the software program includes a navigation software program.

18. A remote entry device comprising:
a housing;
a cover to attach to the housing;
a remote entry component to transmit a signal for an action to occur, wherein the remote entry component is enclosed by the housing and draws power from a battery;
a memory storage component having a memory accessible through an interface extending from the housing, wherein the memory stores information regarding the remote entry device; and
at least one sliding part on the outside of the housing that detaches the cover from the housing.

19. The remote entry device of claim 18, wherein the interface is configured to allow user access to the memory.

20. The remote entry device of claim 18, wherein the battery is charged via the interface.

21. The remote entry device of claim 18, wherein the interface is compatible with a universal serial bus (USB) interface, an infrared signal, a low frequency radio signal, Bluetooth or a radio frequency signal.

22. The remote entry device of claim 18, wherein the information includes setting preference information for a user.

23. The remote entry device of claim 18, wherein the information includes a pass code.

24. The remote entry device of claim 18, further comprising a program configured to execute a password function to deny access to the memory chip.

25. The remote entry device of claim 18, wherein the information includes a software program to execute a function.

26. The remote entry device of claim 25, wherein the software program includes a navigation function.

27. A remote entry device comprising:
a housing;
a cover to attach to the housing, wherein the cover includes an aperture and connection guides to insert into the housing;
a remote entry component within the housing, wherein the remote entry component includes a battery and a button to indicate a signal to transmit to a receiver;
a memory storage component within the housing, wherein the memory storage component includes a printed circuit board to support a flash drive connected to a memory that stores data regarding the remote entry device;
an interface that extends from the housing to interface with a port to allow user access to the flash drive and to recharge the battery, wherein the cover encloses the connector when attached to the housing; and
a light emitting diode (LED) to indicate the connector is engaged with the port.

28. The remote entry device of claim 27, wherein the interface is slidable within the housing.

29. A keyless system comprising:
a receiver to facilitate in performing an action at a location;
a remote entry device having a transmitter to transmit a signal to the receiver, wherein the signal corresponds to the action;
a memory storage component within the remote entry device that stores data and is accessible by a user via a flash drive; and
an interface for the remote entry device to couple the memory storage component with another device.

30. The keyless system of claim 29, wherein the location comprises a vehicle.

31. A method for performing an action within using a remote entry device, the method comprising:
connecting the remote entry device to a port;
reading data regarding the action from a memory storage component within the remote entry device; and
performing the action with a device hosting the port.

32. The method of claim 31, further comprising writing the data to the memory storage component.

33. The method of claim 31, further comprising storing the data at the device.

34. A remote entry device comprising:
means for transmitting a signal in a keyless system;
means for storing information regarding the remote entry device; and
means for connecting to an interface to access the means for storing.

35. The remote entry device of claim 34, wherein the means for storing includes a flash drive.
